(19) United States
(12) Patent Application Publication
(10) Pub. No.: US 2008/0083468 A1
(43) Pub. Date: Apr. 10, 2008

(54) MAGNETIC FILTERING HOSE

(75) Inventors: Gina T. Clark, Lambertville, MI (US); James P. Barnhouse, Perrysburg, OH (US); Christopher L. Schwab, Toledo, OH (US); Jason W. Dahms, Bowling Green, OH (US); Troy M. Lutz, Monclova, OH (US); Michael P. Wells, Bowling Green, OH (US); Ryan J. Williams, Sylvania, OH (US); Christopher M. Bunde, Whitehouse, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: Eaton Corporation, Cleveland, OH (US)

(21) Appl. No.: 11/860,072

(22) Filed: Sep. 24, 2007

Related U.S. Application Data
(60) Provisional application No. 60/826,620, filed on Sep. 22, 2006.

(51) Int. Cl. B03C 1/32; B01D 35/06; F16L 11/00; F16L 11/14; F16L 55/00

(52) U.S. Cl. 138/103; 138/137; 138/138; 210/222; 96/1; 96/2

(57) ABSTRACT

A hose for filtering metallic particles present in a fluid is provided. The hose includes a tubular core through which the fluid passes that has an inner surface, an outer sheathing, and at least one reinforcement layer provided between the tubular core and the outer sheathing. One or more of, the tubular core, the at least one reinforcement layer, and the outer sheathing, is configured to create a sufficient magnetic field to attract at least a portion of the metallic particles present in the fluid and collect them on the inner surface of the tubular core.

### CROSS-REFERENCE TO RELATED APPLICATION

This application claims priority to U.S. Provisional Patent Application No. 60/826,620 filed on Sep. 22, 2006, the disclosure of which is hereby incorporated by reference in its entirety herein.

### BACKGROUND

1. Field of the Invention

The present application relates to a hose for conveying fluid and, more particularly, to a hose that is configured to operate as a magnetic filtering hose to magnetically collect metallic particles present in the fluid.

2. Description of the Related Art

Generally, the function of the lubrication system of an internal combustion engine is to supply clean oil to the critical points in the engine, where the motion of the engine parts produces hydrodynamic oil films that separate and support the various rubbing surfaces. Since the lubricating oil flows to all parts of the engine, it is important that it does not carry abrasive and/or corrosive debris with it. Such debris may come from the combustion of fuel, from dirt in the inducted air, or from the engine parts themselves. It is common practice to filter oil or a portion of the oil as it flows through the lubrication system to reduce wear.

In some engines, a portion of the oil exiting the oil pump is continually bypassed through a filter and returned to the crankcase, while the remaining portion of the oil is directed to the bearings. Since considerable time is required for all of the oil to be filtered by this method, most engines pump all of the oil through a full flow filter placed in line between the oil pump and the bearings. Ideally, such a full flow filter would filter from the oil all of the abrasive and/or corrosive debris, even the microscopic metal particles that are abraded from the moving surfaces of the engine parts during the normal wearing process. However, for a filter to remove all of this debris, the filter would have to be designed and constructed of a material suitable to remove these microscopic particles, and such a filter would severely impede the flow of oil to a degree where insufficient oil would flow to the bearings, and also would require excessively high pressures to force the oil through this fine material. Hence, oil filters are designed to allow the oil and its additives to freely circulate and, thus, do not effectively remove the very small abrasive and/or corrosive debris that circulate with the oil as a result of the normal wearing process that occurs in the engine.

Additionally, it is desirable to filter the fuel as it enters the fuel delivery system to help insure the smooth operation of the fuel delivery system. Primary fuel filters are commonly used to filter debris contained in the fuel. Aside from the debris originally contained within the fuel, the fuel can pick up additional debris as it passes through the fuel delivery system. This additional debris is produced during the manufacturing of the components of the fuel delivery system and includes extremely small particles that cannot be completely removed after the manufacturing process is complete. Various secondary fuel filters have been used in an attempt to filter the additional debris picked up by the fuel as the fuel travels through the fuel delivery system.

### SUMMARY

In one embodiment, a hose for filtering metallic particles present in a fluid is provided. The hose includes a tubular core through which the fluid passes that has an inner surface, an outer sheathing, and at least one reinforcement layer provided between the tubular core and the outer sheathing. One or more of, the tubular core, the at least one reinforcement layer, and the outer sheathing, is configured to create a sufficient magnetic field to attract at least a portion of the metallic particles present in the fluid and collect them on the inner surface of the tubular core.

In another embodiment, a hose for filtering metallic particles present in a fluid is provided. The hose includes a tubular core through which the fluid passes that has an inner surface, an insulation layer, a first reinforcement layer provided between the tubular core and the insulation layer, an outer sheathing, and a second reinforcement layer provided between the insulation layer and the outer sheathing. One or more of, the tubular core, the first reinforcement layer, the insulation later, the second reinforcement layer, and the outer sheathing, is configured to create a sufficient magnetic field to attract at least a portion of the metallic particles present in the fluid and collect them on the inner surface of the tubular core.

In another embodiment, a hose for filtering metallic particles present in a fluid is provided. The hose includes a tubular core through which the fluid passes that has an inner surface, an outer sheathing, at least one reinforcement layer provided between the tubular core and the outer sheathing, and at least one bracelet or ring disposed about the outer sheathing. The bracelet or ring is magnetically charged or constructed of a inherently magnetic material to create a sufficient magnetic field to attract at least a portion of the metallic particles present in the fluid and collect them on the inner surface of the tubular core.

In another embodiment, a hose for filtering metallic particles present in a fluid is provided. The hose includes a tubular core through which fluid passes that has an inner surface, an outer sheathing, at least one reinforcement layer provided between the tubular core and the outer sheathing, and an electromagnetic coil spirally wound about the outer sheathing. The electromagnetic coil is selectively energized to create a sufficient magnetic field to attract at least a portion of the metallic particles present in the fluid and collect them on the inner surface of the tubular core.

### BRIEF DESCRIPTION OF THE DRAWINGS

It will be appreciated that the illustrated boundaries of elements in the drawings represent only one example of the boundaries. One of ordinary skill in the art will appreciate that a single element may be designed as multiple elements or that multiple elements may be designed as a single element. An element shown as an internal feature may be implemented as an external feature and vice versa.

Further, in the accompanying drawings and description that follow, like parts are indicated throughout the drawings and description with the same reference numerals, respectively. The figures may not be drawn to scale and the proportions of certain parts have been exaggerated for convenience of illustration.

FIG. 1 illustrates a top plan view, partly cut-away, of one embodiment of a hose 10 that can be modified to operate as a magnetic filtering hose.

FIG. 2 illustrates a top plan view, partly cut-away, of another embodiment of a hose 200 that can be modified to operate as a magnetic filtering hose.

FIG. 3 illustrates a top plan view, partly cut-away, of another embodiment of a hose 300 that can operate as a magnetic filtering hose.

### DETAILED DESCRIPTION

Certain terminology will be used in the foregoing description for convenience in reference only and will not be limiting. For example, the terms “forward,” “rearward,” “right,” “left,” “upper,” and “lower” designate directions in the drawings to which reference is made, with the terms “inward,” “interior,” or “inner” and “outward,” “exterior,” or “outer” referring, respectively, to directions toward and away from the center of the referenced element, and the terms “radial” and “axial” referring, respectively, to directions perpendicular and parallel to the central longitudinal axis of the referenced element.

This application is directed to a hose that is configured to filter metallic debris or particles present in a fluid passing through the hose. Specifically, the hose is configured to magnetically attract the metallic debris or particles present in the fluid and collect it inside one or more internal surfaces of the hose.

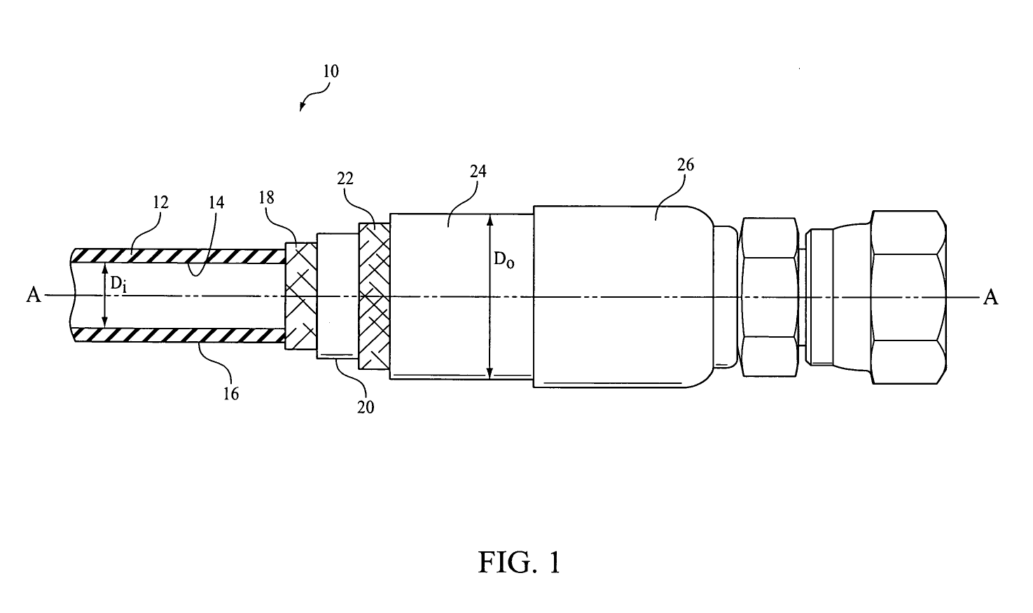

Illustrated in FIG. 1 is a top plan view, partly cut-away, of one embodiment of a hose 10 for conveying a fluid, such as air, hydraulic oil, lubricating oil or fuel. In basic dimensions, the hose 10 extends axially to a predetermined length along a central longitudinal axis A and has an inner diameter Dᵢ and outer diameter Dₒ. The dimensions of the inner diameter Dᵢ and the outer diameter Dₒ may vary depending upon the particular fluid conveying application involved.

The hose 10 includes a tubular core 12 through which fluid passes. The tubular core 12 has an inner surface 14, which defines the inner diameter Dᵢ, and an outer surface 16. As with the overall dimensions of the hose 10, the wall thickness of the tubular core 12 may vary depending upon the particular fluid conveying application involved. In the illustrated embodiment, the tubular core 12 has a unitary, single-layer construction that is constructed of a polymeric or elastomeric composition. Alternatively, the tubular core 12 may be formed of a composite construction. In such a composite construction, the tubular core 12 can include an innermost layer or liner, which defines the inner tube surface, and an outermost layer, which defines the outer core tube surface. Optionally, an intermediate layer may be provided between the inner most and outer most layers if these two layers are formed of chemically dissimilar or otherwise incompatible materials. Exemplary composite tubular cores are described in U.S. Pat. Nos. 3,561,493; 5,076,329; 5,167,259; 5,284,184; 5,383,087; 5,419,374; 5,460,771; 5,469,892; 5,500,257; 5,554,425; 5,566,720; and 5,622,210; 5,678,611, the disclosures of which are hereby incorporated by reference in their entireties herein.

The hose 10 also includes a first reinforcement layer 18 surrounding the tubular core 12. In the illustrated embodiment, the first reinforcement layer 18 includes a braided reinforcement material. Alternatively, the first reinforcement layer 18 can include a spirally wound, knitted, or wrapped reinforcement material. Additionally, the first reinforcement layer 18 may include a single ply or multiple plies of reinforcement materials and may fully cover the tubular core 12 or partially cover the tubular core 12 (e.g., 50% coverage). In alternative embodiments (not shown), the hose 10 may not include the first reinforcement layer 18 in certain applications.

The reinforcement material can include, for example, a metal wire (monofilament or multi-filament) made from carbon steel, stainless steel, galvanized steel, zinc plated steel, brass, steel alloys, and blends thereof. Alternatively, the reinforcement material can include natural fibers and textiles, synthetic fibers and textiles, or other reinforcement materials typically found in hose constructions.

The hose 10 also includes an insulation layer 20 surrounding the first reinforcement layer 18. In the illustrated embodiment, the insulation layer 20 has a unitary, single-layer construction that is constructed of a polymeric or elastomeric composition. Alternatively, the insulation layer 20 may be formed of a composite construction. Although the illustrated embodiment includes a single insulation layer, it will be appreciated that the hose 10 can include two or more insulation layers depending upon the particular fluid conveying application involved. Moreover, the hose 10 may not include an insulation layer in certain applications.

The hose 10 also includes a second reinforcement layer 22 surrounding the insulation layer 20. The second reinforcement layer 22 can be similar in construction to the first reinforcement layer 18 discussed above. In the illustrated embodiment, the second reinforcement layer 18 includes a braided reinforcement material. Although the illustrated embodiment includes two reinforcement layers, it will be appreciated that the hose 10 can include a single reinforcement layer or three or more reinforcement layers depending upon the particular fluid conveying application involved.

The hose 10 further includes an outer sheathing or jacket 24 surrounding the second reinforcement layer 22. In the illustrated embodiment, the outer sheathing 24 has an outer surface that defines the outer diameter Dₒ and a unitary, single-layer construction that is formed of a polymeric or elastomeric composition such as, for example, an abrasion-resistant material. In an alternative embodiment (not shown), the outer sheathing 24 may be formed of a composite construction.

As shown in FIG. 1, the hose 10 terminates at a coupling 26 that is configured to be connected to a corresponding coupling (not shown) on a separate component (not shown). The coupling 26 may be constructed of a metal or a polymeric material. In the illustrated embodiment, the coupling 26 includes a nut having internal threads for attachment to external threads of the corresponding coupling. Alternatively, the coupling 26 can include other suitable connection means for attachment to a separate component (not shown).

It will be appreciated that the hose 10 described above and illustrated in FIG. 1 is merely one example of a hose used for conveying fluids and that many other hose constructions are possible. For example, in other hoses, the order of the reinforcement and insulation layers can be altered to suit a particular application. For instance, the insulation layer 20 can be applied directly over the tubular core 12, with the first and second reinforcement layers 18, 22 applied over the insulation layer 20. In other instances, one or more of: the insulation layer 20, the first and second reinforcement layers 18, 22, and the outer sheathing 24 can be eliminated.

The hose 10 described above and illustrated in FIG. 1 can be modified to render it a magnetic filtering hose, such that it is configured to magnetically attract metallic debris or particles present in the fluid passing through the tubular core 12 of the hose 10 and to collect such metallic debris or particles on the inner surface 14 of the tubular core 12 of the hose 10. To accomplish this, the hose 10 can be modified in at least six configurations.

In one configuration, the tubular core 12 can be constructed of a magnetic polymeric or elastomeric composition, such that it creates a magnetic field that is directed radially outward from the longitudinal axis A of the hose 10. Due to the creation of this magnetic field, metallic debris or particles present in the fluid passing through the tubular core 12 can be attracted radially outward towards the inner surface 14 of the tubular core 12 and collect thereon, thereby removing the metallic debris or particles from the fluid.

The magnetic polymeric or elastomeric composition can include, among other things, a magnetic powder that can be selected from a wide variety of iron, nickel and cobalt compounds that have ferromagnetic capacity. One suitable example of a magnetic polymeric composition is disclosed in U.S. Pat. No. 6,359,051, the disclosure of which is hereby incorporated by reference in its entirety herein.

In a second configuration, the reinforcement material (e.g., the metal wire) that comprises the first reinforcement layer 18 is magnetically charged in such a way that it creates a magnetic field that is directed radially outward from the longitudinal axis A of the hose 10. Alternatively, the reinforcement material can be constructed of an inherently magnetic material such as, for example, neodymium iron boron (NdFeB), samarium cobalt (SmCo), aluminum nickel cobalt (AlNiCo), ferrite, ferrite/ceramic material, and combinations thereof. Due to the creation of this magnetic field, metallic debris or particles present in the fluid passing through the tubular core can be attracted radially outward towards the inner surface 14 of the tubular core 12 and collect thereon, thereby removing the metallic debris or particles from the fluid.

In a third configuration, the insulation layer 20 can be constructed of a magnetic polymeric or elastomeric composition similar to the one discussed above with respect to the composition of the tubular core 12, such that the magnetic polymeric or elastomeric composition creates a magnetic field that is directed radially outward from the longitudinal axis A of the hose 10. Due to the creation of this magnetic field, metallic debris or particles present in the fluid passing through the tubular core 12 can be attracted radially outward towards the inner surface 14 of the tubular core 12 and collect thereon, thereby removing the metallic debris or particles from the fluid.

In a fourth configuration, the reinforcement material (e.g., the metal wire) that comprises the second reinforcement layer 22 is magnetically charged in such a way that it creates a magnetic field that is directed radially outward from the longitudinal axis A of the hose 10. Alternatively, the reinforcement material can be constructed of one or more of the inherently magnetic materials discussed above. Due to the creation of this magnetic field, metallic debris or particles present in the fluid passing through the tubular core 12 can be attracted radially outward towards the inner surface 14 of the tubular core 12 and collect thereon, thereby removing the metallic debris or particles from the fluid.

In a fifth configuration, the outer sheathing 24 is constructed of a magnetic polymeric or elastomeric composition similar to the one discussed above with respect to the composition of the tubular core 12, such that the magnetic polymeric or elastomeric composition creates a magnetic field that is directed radially outward from the longitudinal axis A of the hose 10. Due to the creation of this magnetic field, metallic debris or particles present in the fluid passing through the tubular core 12 can be attracted radially outward towards the inner surface 14 of the tubular core 12 and collect thereon, thereby removing the metallic debris or particles from the fluid.

In a sixth configuration, the coupling member 26 is constructed of a material (e.g., metal or plastic) that is magnetically charged in such a way that it creates a magnetic field that is directed radially outward from the longitudinal axis A of the construction hose 10. Alternatively, the coupling can be constructed of one or more of the inherently magnetic materials discussed above. Due to the creation of this magnetic field, metallic debris or particles present in the fluid passing through the tubular core 12 can be attracted radially outward towards the inner surface 14 of the tubular core 12 and collect thereon, thereby removing the metallic debris or particles from the fluid.

It will be appreciated that any one of the six configurations discussed above can be used alone or in combination with one or more of the other configurations. For example, in one embodiment of a magnetic filtering hose, the tubular core 12 can be constructed of a magnetic polymeric or elastomeric composition (first configuration) and the outer sheathing 24 can be constructed of a magnetic polymeric or elastomeric composition (sixth configuration).

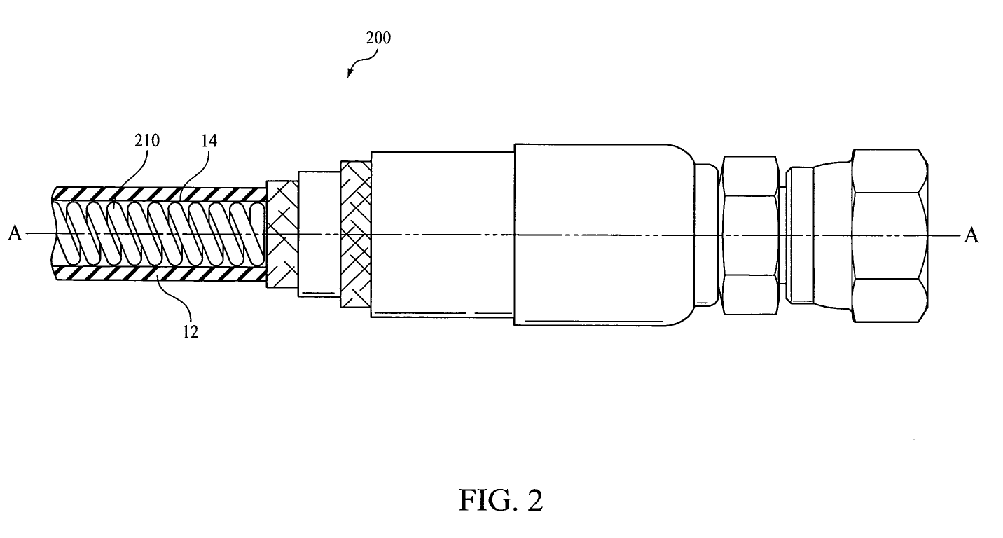

Illustrated in FIG. 2 is a top plan view, partly cut-away, of another embodiment of a hose 200. The hose 200 is substantially similar to the hose 10 described above and illustrated in FIG. 1, with the exception that it includes a support coil 210 provided within the tubular core 12. When the hose 200 is used as a suction hose, the support coil 210 prevents the tubular core 12 from collapsing under vacuum. The support coil 210 may be constructed of a metal or polymeric material.

The hose 200 as described above and illustrated in FIG. 2 can be modified to render it a magnetic filtering hose, such that the hose 200 is configured to magnetically attract metallic debris or particles present in the fluid passing through the tubular core 12 of the hose 200 and collect the metallic debris or particles on the inner support coil 210. For example, the support coil 210 can be constructed of a material that is magnetically charged in such a way that it creates a magnetic field that is directed radially outward from the longitudinal axis A of the hose 200. Due to the creation of this magnetic field, metallic particles or debris present in the fluid passing through the tubular core 12 can be attracted radially outward towards the support coil 210 and collect thereon, thereby removing the metallic debris or particles from the fluid. In another embodiment, the support coil 210 is constructed of one or more of the inherently magnetic materials discussed above.

In another embodiment (not shown), the support coil 210 can be replaced with a sleeve (e.g., a cylindrical tube) that is configured to prevent the tubular core 12 from collapsing under vacuum. Like the support coil 210, the sleeve can be constructed of a material that is magnetically charged or constructed of one or more of the inherently magnetic materials discussed above to attract the metallic particles thereto.

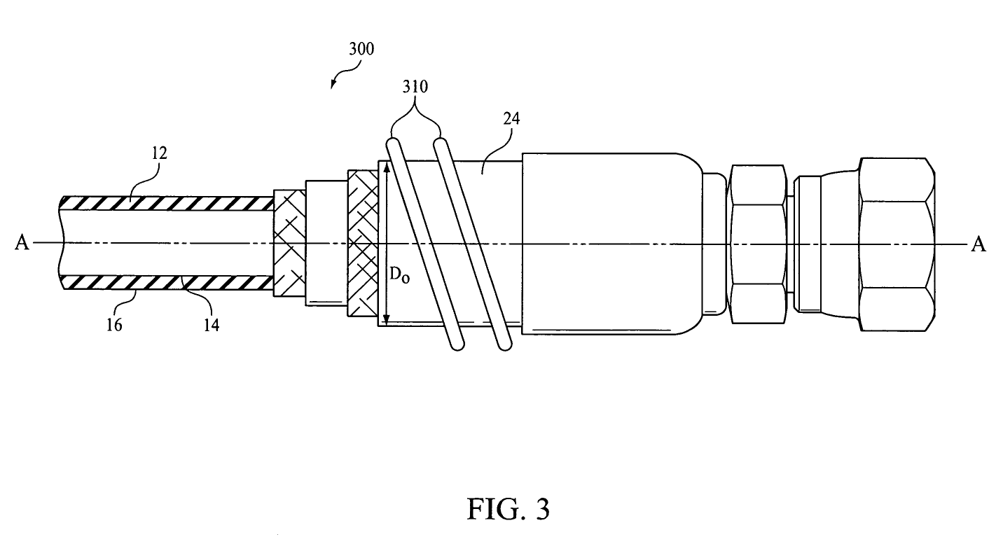

Illustrated in FIG. 3 is a top plan view, partly cut-away, of another embodiment of a hose 300 that can be operated as a magnetic filtering hose. The hose 300 is substantially similar to the hose 10 described above and illustrated in FIG. 1, with the exception that it includes magnetic bracelets or rings 310 disposed about the outer sheathing 24. Although the illustrated embodiment shows two magnetic bracelets, it will be appreciated that the hose 300 can include a single magnetic bracelet or three or more magnetic bracelets.

The magnetic bracelets 310 are configured to create a magnetic field that is directed radially outward from the longitudinal axis A of the hose 300. Due to this magnetic field, metallic particles or debris present in the fluid passing through the tubular core 12 can be attracted radially outward towards the inner surface 14 of the tubular core 12 and collect thereon, thereby removing the metallic debris or particles from the fluid.

The magnetic bracelets 310 can be constructed of a variety of an inherently magnetic material, such as neodymium iron boron (NdFeB) magnets, samarium cobalt (SmCo), aluminum nickel cobalt (AlNiCo), ferrite, ferrite/ceramic material, and combinations thereof. Alternatively, the magnetic bracelets 310 can be constructed of any material that is magnetically charged.

In one embodiment (not shown), the hose 300 includes at least one retainer to secure the magnetic bracelets 310 to the outer sheathing 24 or the coupling 26, such that they are prevented them from sliding along the length of the magnetic filtering hose 300. Alternatively, the dimension of the internal diameter of the magnetic bracelets 310 can be slightly less than the outer diameter Dₒ of the hose 300 to provide a friction fit between the magnetic bracelets 310 and the outer sheathing 24. In another embodiment (not shown), the magnetic bracelets 310 can be replaced with a sleeve that is constructed of an inherently magnetic material or a material that is magnetically charged.

In another embodiment (not shown), an electromagnetic coil can be spirally wound around the outer sheathing of a conventional hose (e.g., the hose 10 described above and illustrated in FIG. 1). The electromagnetic coil can be energized whenever an engine is operating so that, during operation of the engine, the electromagnetic coil can be activated. The electromagnetic coil can be configured in such a way that there is enough residual magnetism to hold the collected metallic debris or particles when the engine is turned off. However, even if the metallic debris or particles fall off the inner surface 14 of the tubular core 12, as soon as the electromagnetic coil is energized, the metallic debris or particles can be re-attracted to the inner surface 14 of the tubular core 12 and not swept away by the oil.

It will be appreciated that any of the configurations or embodiments discussed above can be used alone or in combination with each other. For example, in one embodiment of a magnetic filtering hose, the tubular core 12 can be constructed of a magnetic polymeric or elastomeric composition (first configuration, FIG. 1) and the inner support coil 210 can be magnetically charged or can be constructed of an inherently magnetic material (FIG. 2).

The exemplary magnetic filtering hoses described above and illustrated in FIGS. 1-3 can be used in a variety of applications. For example, they can be used to filter oil in a lubrication system of an internal combustion engine. Additionally, they can be used to filter fuel in a fuel delivery system of an internal combustion engine. In either application, the magnetic filtering hoses are configured to magnetically attract and retain metallic debris or particles present in the fluid (oil and/or fuel) passing therethrough, thereby reducing the amount of metallic debris or particles that enter the engine.

The exemplary magnetic filtering hoses described above and illustrated in FIGS. 1-3 have several potential advantages. First, the use of a magnetic filtering hose in a lubricating oil system and/or a fuel delivery system can, in some circumstances, eliminate the need for an oil filter and/or fuel filter, respectively, which would, in turn, reduce cost and part numbers. Also, the amount of space in an engine compartment could be increased due to the elimination of the oil filter and/or fuel filter.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

While the present application illustrates various embodiments, and while these embodiments have been described in some detail, it is not the intention of the applicant to restrict or in any way limit the scope of the claimed invention to such detail. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's claimed invention. Moreover, the foregoing embodiments are illustrative, and no single feature or element is essential to all possible combinations that may be claimed in this or a later application.

What is claimed is:

1. A hose for filtering metallic particles present in a fluid, the hose comprising:
a tubular core through which the fluid passes, the tubular core having an inner surface;
an outer sheathing; and
at least one reinforcement layer provided between the tubular core and the outer sheathing,
wherein one or more of, the tubular core, the at least one reinforcement layer, and the outer sheathing, is configured to create a sufficient magnetic field to attract at least a portion of the metallic particles present in the fluid and collect them on the inner surface of the tubular core.

2. The hose of claim 1, wherein the tubular core is constructed of a magnetic polymeric composition configured to create a sufficient magnetic field to attract at least a portion of the metallic particles present in the fluid and collect them on the inner surface of the tubular core.

3. The hose of claim 1, wherein the reinforcement layer includes braided metal wire that is sufficiently magnetically charged or constructed of a inherently magnetic material to create a magnetic field to attract at least a portion of the metallic particles present in the fluid and collect them on the inner surface of the tubular core.

4. The hose of claim 1, wherein the reinforcement layer includes spiral wound metal wire that is sufficiently magnetically charged or constructed of a inherently magnetic material to create a magnetic field to attract at least a portion of the metallic particles present in the fluid and collect them on the inner surface of the tubular core.

5. The hose of claim 1, wherein the outer sheathing is constructed of a magnetic polymeric composition configured to create a sufficient magnetic field to attract at least a portion of the metallic particles present in the fluid and collect them on the inner surface of the tubular core.

6. The hose of claim 1, further comprising a metal coupling secured to one end of the hose, the metal coupling being sufficiently magnetically charged or constructed of a inherently magnetic material to create a magnetic field to attract at least a portion of the metallic particles present in the fluid and collect them on the inner surface of the tubular core.

7. The hose of claim 1, further comprising a support coil or sleeve disposed in the tubular core, the support coil or sleeve being sufficiently magnetically charged or constructed of a inherently magnetic material to create a magnetic field to attract at least a portion of the metallic particles present in the fluid and collect them on the inner surface of the tubular core.

8. The hose of claim 1, further comprising at least one bracelet or ring disposed about the outer sheathing, the bracelet or ring being sufficiently magnetically charged or constructed of a inherently magnetic material to create a magnetic field to attract at least a portion of the metallic particles present in the fluid and collect them on the inner surface of the tubular core.

9. The hose of claim 8, further comprising at least one retainer configured to secure the at least one bracelet or ring to the outer sheathing or a coupling that is secured to an end of the hose.

10. A hose for filtering metallic particles present in a fluid, the hose comprising:
a tubular core through which the fluid passes, the tubular core having an inner surface;
an insulation layer;
a first reinforcement layer provided between the tubular core and the insulation layer;
an outer sheathing; and
a second reinforcement layer provided between the insulation layer and the outer sheathing,
wherein one or more of, the tubular core, the first reinforcement layer, the insulation later, the second reinforcement layer, and the outer sheathing, is configured to create a sufficient magnetic field to attract at least a portion of the metallic particles present in the fluid and collect them on the inner surface of the tubular core.

11. The hose of claim 10, wherein the tubular core is constructed of a magnetic polymeric composition configured to create a sufficient magnetic field to attract at least a portion of the metallic particles present in the fluid and collect them on the inner surface of the tubular core.

12. The hose of claim 10, wherein the first reinforcement layer includes braided metal wire that is magnetically charged or constructed of a inherently magnetic material to create a sufficient magnetic field to attract at least a portion of the metallic particles present in the fluid and collect them on the inner surface of the tubular core.

13. The hose of claim 10, wherein the first reinforcement layer includes spiral wound metal wire that is magnetically charged or constructed of a inherently magnetic material to create a sufficient magnetic field to attract at least a portion of the metallic particles present in the fluid and collect them on the inner surface of the tubular core.

14. The hose of claim 10, wherein the insulation layer is constructed of a magnetic polymeric composition configured to create a sufficient magnetic field to attract at least a portion of the metallic particles present in the fluid and collect them on the inner surface of the tubular core.

15. The hose of claim 10, wherein the second reinforcement layer includes braided metal wire that is magnetically charged or constructed of a inherently magnetic material to create a sufficient magnetic field to attract at least a portion of the metallic particles present in the fluid and collect them on the inner surface of the tubular core.

16. The hose of claim 10, wherein the second reinforcement layer includes spiral wound metal wire that is magnetically charged or constructed of a inherently magnetic material to create a sufficient magnetic field to attract at least a portion of the metallic particles present in the fluid and collect them on the inner surface of the tubular core.

17. The hose of claim 10, wherein the outer sheathing is constructed of a magnetic polymeric composition configured to create a sufficient magnetic field to attract at least a portion of the metallic particles present in the fluid and collect them on the inner surface of the tubular core.

18. The hose of claim 10, further comprising a metal coupling secured to one end of the hose, the metal coupling being magnetically charged or constructed of a inherently magnetic material to create a sufficient magnetic field to attract at least a portion of the metallic particles present in the fluid and collect them on the inner surface of the tubular core.

19. The hose of claim 10, further comprising a support coil or sleeve disposed in the tubular core, the support coil or sleeve being magnetically charged or constructed of a inherently magnetic material to create a sufficient magnetic field to attract at least a portion of the metallic particles present in the fluid and collect them on the inner surface of the tubular core.

20. The hose of claim 10, further comprising at least one bracelet or ring disposed about the outer sheathing, the bracelet or ring being magnetically charged or constructed of a inherently magnetic material to create a sufficient magnetic field to attract at least a portion of the metallic particles present in the fluid and collect them on the inner surface of the tubular core.

21. The hose of claim 20, further comprising at least one retainer configured to secure the at least one bracelet or ring to the outer sheathing or a coupling that is secured to an end of the hose.

22. A hose for filtering metallic particles present in a fluid, the hose comprising:
a tubular core through which the fluid passes, the tubular core having an inner surface;
an outer sheathing;
at least one reinforcement layer provided between the tubular core and the outer sheathing; and
at least one bracelet or ring disposed about the outer sheathing, the bracelet or ring being magnetically charged or constructed of a inherently magnetic material to create a sufficient magnetic field to attract at least a portion of the metallic particles present in the fluid and collect them on the inner surface of the tubular core.

23. The hose of claim 22, further comprising at least one retainer configured to secure the at least one bracelet or ring to the outer sheathing or a coupling that is secured to an end of the hose.

24. A hose for filtering metallic particles present in a fluid, the hose comprising:
a tubular core through which fluid passes, the tubular core having an inner surface;
an outer sheathing;
at least one reinforcement layer provided between the tubular core and the outer sheathing; and
an electromagnetic coil spirally wound about the outer sheathing, the electromagnetic coil being selectively energized to create a sufficient magnetic field to attract at least a portion of the metallic particles present in the fluid and collect them on the inner surface of the tubular core.
